(19) United States
(12) Patent Application Publication
(10) Pub. No.: US 2022/0208027 A1
(43) Pub. Date: Jun. 30, 2022

(54) SEALING FILM

(71) Applicant: Securikett Ulrich & Horn GmbH, Muenchendorf (AT)

(72) Inventor: Marietta ULRICH-HORN, Moedling (AT)

(73) Assignee: Securikett Ulrich & Horn GmbH, Muenchendorf (AT)

(21) Appl. No.: 17/603,438

(22) PCT Filed: Apr. 17, 2020
(86) PCT No.: PCT/EP2020/060915

§ 371 Date: Oct. 13, 2021

(30) Foreign Application Priority Data
Apr. 19, 2019 (EP) 19170374.3

(51) Int. Cl. G09F 3/03; G09F 3/00; G09F 3/10

(52) U.S. Cl. CPC G09F 3/0376; G09F 3/0341; G09F 2003/0222; G09F 3/0297; G09F 3/10; G09F 3/0292

(57) ABSTRACT

Sealing film for application to a base surface includes a carrier film and functional layers that include at least two color display layers and at least two adhesion-controlling layers. The sealing film has an adhesive layer for attachment to the base surface. The functional layers are arranged between the carrier film and the adhesive layer. The carrier film is detachable, at least partially, from the functional layers. In a second state at least one symbol is optically visible but not visible in a first state. The at least two adhesion-controlling layers separate defined regions from the at least two color display layers during carrier film detachment. The functional layers include at least one further adhesion-controlling layer, to make at least one layer behind the further adhesion-controlling layer, viewed from the carrier film toward the adhesive layer, visible in the second state, at least in certain sections, via the detachment.

### FIELD OF THE INVENTION

The present invention relates to a sealing film for application to a base surface, comprising a carrier film and multiple functional layers, wherein the functional layers comprise at least two color display layers and at least two adhesion-controlling layers, wherein the sealing film has an adhesive layer for attachment to the base surface, wherein the functional layers are arranged between the carrier film and the adhesive layer, wherein the carrier film can be at least partially detached from the functional layers, in particular from the at least two color display layers, so as to bring the sealing film from a first state into a second state, wherein in the second state at least one symbol is optically visible, which symbol is not visible in the first state, wherein during detachment of the carrier film, regions defined by the at least two adhesion-controlling layers can be removed from the at least two color display layers, so as to make the at least one symbol visible.

### STATE OF THE ART

Aside from protecting containers or packaging against unauthorized opening, sealing films can also be used to cover confidential information. The confidential information can be, for example, a PIN code or QR code, a hologram or an identity code. The confidential information becomes visible to the observer only after the sealing film has been pulled off.

A disadvantage of conventional sealing films lies in the fact that they are often easy to manipulate. In many cases, it is possible to open a sealing film, which has been applied to a base surface, for example to a paper or to a cardboard, manually or with the aid of a tool, such as a knife, and to subsequently re-apply it in its original position, so that the observer does not notice that the manipulation has taken place.

For this reason, varied sealing films exist, which can be applied to a base surface by means of an adhesive layer, in which the adhesive layer prevents manual detachment or detachment using a tool, such as a knife. Such sealing films cannot be detached from the base surface, in each instance, without a visible change in their optics, as the result of preparation of the separation forces or the adhesion capacity within a multi-layer structure of the sealing film. Often a graphic symbol appears after detachment, indicating that detachment has occurred.

In AT 009 366 U1, a closure label is disclosed, by means of which label opening of a packaging element that has taken place is clearly and irreversibly indicated. The closure label has multiple layers that are partially connected with one another, wherein an upper layer can be partially detached from a lower layer. By means of detachment of the upper layer, defined regions of a coating arranged between upper layer and lower layer, in particular of a color layer, can be removed using at least one release varnish layer. As a result, a graphic object that was previously hidden to the observer becomes optically visible in an emblem region of the closure label, and thereby opening of the packaging element that has taken place is clearly and irreversibly indicated.

It is a disadvantage of the known closure label that when the carrier film is detached from the other layers, a symbol that has only relatively low contrast is formed. This implies the risk that the carrier film will be re-applied to the lower layers, and that the observer will recognize only with difficulty whether the closure label was already detached, since the manipulated and the non-manipulated closure label hardly differ from one another. In other words such a closure label is only conditionally suitable for covering confidential information, since the observer cannot be certain whether the confidential information was previously read by another person.

EP 0 974 951 B1 discloses a label for covering information, in particular PINs, with an adhesive layer, a base layer, and a color layer that can be irreversibly removed by means of rubbing it. An authenticity feature is affixed to the color layer, which feature is damaged or destroyed when the color layer is removed, so that one can see immediately whether the color layer has been manipulated.

It is a disadvantage of the known label that an additional production step is necessary, since an extra color layer, which is usually very thick so as to sufficiently conceal the information, must be applied to the base layer.

### TASK OF THE INVENTION

It is therefore the task of the present invention to make available a sealing film that overcomes the disadvantages of the state of the art and makes a code visible, wherein upon detachment of a carrier film, a particularly contrast-rich symbol occurs, and thereby prior manipulation of the sealing film is indicated by means of a clear indication of the opened state, and wherein production is simple and cost-advantageous.

### PRESENTATION OF THE INVENTION

The task stated initially is accomplished, according to the invention, in the case of a sealing film for application to a base surface, comprising a carrier film and multiple functional layers, wherein the functional layers comprise at least two color display layers and at least two adhesion-controlling layers, wherein the sealing film has an adhesive layer for attachment to the base surface, wherein the functional layers are arranged between the carrier film and the adhesive layer, wherein the carrier film can be at least partially detached from the functional layers, in particular from the at least two color display layers, so as to bring the sealing film from a first state into a second state, wherein in the second state, at least one symbol is optically visible, which symbol is not visible in the first state, wherein during detachment of the carrier film, regions defined by the at least two adhesion-controlling layers can be removed from the at least two color display layers, so as to make the at least one symbol visible, in that the functional layers comprise at least one further adhesion-controlling layer, so as to make at least one layer that lies behind the further adhesion-controlling layer, viewed from the carrier film in the direction of the adhesive layer, visible in the second state, at least in certain sections.

The structure of the sealing film according to the invention can be summarized as follows: Multiple functional layers are applied between the carrier film and the adhesive layer, wherein the functional layers comprise at least two color display layers and at least two adhesion-controlling layers. During the course of detachment of the carrier film, at least one symbol occurs, wherein regions defined by the at least two adhesion-controlling layers are removed from the at least two color display layers, which regions form the at least one symbol. In other words the at least one symbol remains hidden for an observer before the sealing film according to the invention has been opened for the first time, and it is only optically visible after opening has taken place.

In the second state, the sealing film according to the invention has a pulled-off layer and a remnant that remains adhering to the base surface. The at least one symbol can be visible on the pulled-off layer and/or on the remnant in the second state.

Of course, the defined regions of the at least one color display layer that have been removed do not have to adhere directly to the carrier film or to the adhesive layer, in this regard, but rather can also adhere to them indirectly, by way of further functional layers arranged on the carrier film or on the adhesive layer.

Furthermore, the sealing film according to the invention comprises a further adhesion-controlling layer, which, during the course of detachment of the carrier film, makes a layer visible, at least in certain sections, that lies behind the further adhesion-controlling layer, viewed from the carrier film in the direction of the adhesive layer. In other words the layer that lies behind the further adhesion-controlling layer is not visible in the first state and only becomes visible, at least in part, after detachment of the carrier film, in other words in the second state.

Of course, the sealing film according to the invention can also have any desired number of further functional layers in addition to the functional layers described, which have the goal of production technology advantages or optical effects, for example, without deviating from the idea according to the invention.

By means of the functional layers, something that is optically perceivable, for example a color or a code, is produced or an effect occurs, for example by means of adhesion-controlling layers. In other words, “functional layers” is the umbrella term for the color display layers, the adhesion-controlling layers, and the layer that lies behind the further adhesion-controlling layer, for example.

The color display layers, in turn, can comprise multiple structural layers. In other words, independent of the color of a color display layer, the color display layer comprises one or more structural layers. A dark-gray color display layer, for example, typically comprises a white and a black structural layer, due to the printing process that takes place in practice.

It would be conceivable that the functional layers are applied to one another preferably using flexographic printing methods, screen printing methods, letterpress printing methods, offset printing methods or digital printing methods.

A code is exposed or becomes visible by means of detachment of the carrier film. In this regard, the code can be situated directly on the packaging and/or be part of the sealing film, preferably part of the functional layers that are arranged between the carrier film and the adhesive layer, and/or part of the adhesive layer.

In order to make reading the code barely possible, preferably impossible, at least one of the color display layers can be opaque or contain an interference pattern, or the code can be optically non-contrasting for other reasons.

It would be conceivable that the at least two color display layers have different colors.

Of course, the at least two color display layers can also have the same color, in each instance. In this case, too, at least one symbol can be visible in the second state, since light refraction of those parts of the color display layer that have been removed, by means of the adhesion-reducing layers, during the course of detachment, changes.

The color display layers can be opaque, semi-opaque, translucent or transparent.

Furthermore, it would be conceivable that the at least two color display layers consist, at least in certain sections, in each instance, of different colors, which can be arranged in strip form or raster form or in the form of images and/or patterns, for example.

It should be mentioned that the functional layers do not necessarily have to extend over an entire surface area of the sealing film according to the invention, i.e. over the full area. In other words, it would be conceivable that parts of the functional layers are arranged on the surface of the sealing film according to the invention only in certain sections.

In a preferred embodiment of the sealing film according to the invention, it is provided that the layer that lies behind the further adhesion-controlling layer comprises at least one code composed of optical characters and/or graphical symbols.

Therefore the code is not visible in the first state, either, and only becomes visible after detachment of the carrier film, in other words in the second state. In other words, the code is covered, in the first state, by the at least two color display layers, in such a manner that reading the code that lies under the at least two color display layers is hardly possible, preferably impossible. For this purpose, at least one of the color display layers can be opaque or contain an interference pattern, or the code can be optically non-contrasting for other reasons.

The layer that lies behind the further adhesion-controlling layer is a code display layer in this preferred embodiment.

The code typically contains confidential information. The code can be, for example, a PIN code or QR code, a hologram or an identity code.

Particularly preferably, in the case of the sealing film according to the invention, it is provided that the layer that lies behind the further adhesion-controlling layer is transparent, at least in certain sections, and is encompassed by the functional layers, and that the functional layers comprise at least one further color display layer, which further color display layer is arranged between the layer that lies behind the further adhesion-controlling layer and the adhesive layer. The further color display layer therefore lies behind the layer that lies behind the further adhesion-controlling layer, viewed from the carrier film in the direction of the adhesive layer.

In this particularly preferred embodiment, the functional layers therefore comprise the code, at least in part. In other words, the code is part of the sealing film according to the invention, at least in part.

On the one hand, the further color display layer has the task of making the code legible. In other words, the color of the further color display layer and the color of the code preferably have great contrast, and thereby the code is clearly visible on the further color display layer, which lies behind it, viewed from the carrier film in the direction of the adhesive layer.

On the other hand, the further color display layer can serve as a privacy shield if the sealing film according to the invention, including all its functional layers, is improperly removed from the base surface, for example using a tool. In other words, in such a case the code is not legible through the further color display layer, and is covered, on the back, by the further color display layer.

It would furthermore be possible that the further color display layer serves as a privacy shield if the sealing film according to the invention is applied to a transparent base surface, for example to a glass bottle. In this case, too, the code is not legible—in spite of the transparent base surface—since the further color display layer covers it on the back.

Preferably the further color display layer fulfills both of the stated tasks. It is conceivable that the further color display layer is non-transparent. However, it would also be possible that the further color display layer is transparent or translucent, at least in part.

In a preferred embodiment of the sealing film according to the invention, it is provided that at least the following functional layers are applied to the carrier film, one after the other, preferably directly one after the other, viewed in the direction of the adhesive layer:

a first adhesion-controlling layer,

a first color display layer,

a second adhesion-controlling layer,

a second color display layer,

the further adhesion-controlling layer,

the layer that lies behind the further adhesion-controlling layer, and

the further color display layer.

This arrangement of the functional layers applied one on top of the other has proven itself in the practical experimental field, so as to produce a particularly strong optical contrast in the case of the at least one symbol in the second state, on the one hand, and, on the other hand, to protect the layer that lies behind the further adhesion-controlling layer and comprises the code, in the best possible manner.

Of course, it is conceivable that aside from the functional layers listed above, at least one further functional layer is present.

It would furthermore be conceivable that the code is situated on the base surface. In order to make the code visible on the base surface in the second state, it would be possible that the adhesive layer is not applied under the entire surface area of the sealing film according to the invention, i.e. over the full area—those sections in which the code is supposed to be visible on the base surface in the second state would then be omitted. In other words, in this case the adhesive layer would only be arranged in certain sections underneath the functional layers. As a result, the further adhesion-controlling layer can be eliminated in those sections in which no adhesive layer is present. In other words, in this case the further adhesion-controlling layer could also be present only in certain sections. Of course, it is not excluded that the layer that lies behind the further adhesion-controlling layer could also be present only in certain sections.

If the code is situated on the base surface, and if the adhesive layer is arranged in certain sections, in such a manner so as to make the code visible in the second state, then the sealing film according to the invention must be arranged on the base surface very precisely, so that it can be assured that those sections in which no adhesive layer is present are actually situated above the code on the base surface. In order to not have to arrange the sealing film according to the invention this precisely, it is preferably provided, in the case of the sealing film according to the invention, that the layer that lies behind the further adhesion-controlling layer and the adhesive layer are transparent, at least in certain sections, so as to make a code visible on the base surface in the second state.

The code is preferably situated on the base surface, for example a paper, a cardboard or a packaging element, and is covered by the sealing film in the first state. In other words, in this preferred exemplary embodiment, as well, the code is not visible in the first state, and only becomes visible after detachment of the carrier film, in other words in the second state.

However, it would also be conceivable that the adhesive layer comprises the code, at least in part.

Preferably the code, as described above, is a PIN code or QR code, a hologram or an identity code.

In order to make reading the code barely possible, preferably impossible, at least one of the color display layers can be opaque or contain an interference pattern, or the code that lies underneath can be optically non-contrasting for other reasons.

Of course, in this case, as well, it is not excluded that at least part of the code could also be situated within or on one of the functional layers, preferably on the layer that lies behind the further adhesion-controlling layer. In other words, at least part of the code is situated on the base surface, and at least part of the code is situated within or on one of the functional layers.

In a particularly preferred embodiment of the sealing film according to the invention, it is provided that at least the following functional layers are applied to the carrier film, one after the other, preferably directly one after the other, viewed in the direction of the adhesive layer:

a first adhesion-controlling layer,

a first color display layer,

a second adhesion-controlling layer,

a second color display layer,

the further adhesion-controlling layer, and

the layer that lies behind the further adhesion-controlling layer.

This arrangement of the functional layers applied one on top of the other has proven itself in the practical experimental field, so as to produce a particularly strong optical contrast in the case of the at least one symbol in the second state, on the one hand, and, on the other hand, to protect the code on the base surface and/or in the adhesive layer in the best possible manner.

The layer that lies behind the further adhesion-controlling layer guarantees the effect of the further adhesion-controlling layer, because in this way it is ensured that the adhesion-controlling layer does not come into direct contact with the adhesive layer.

Of course, it is conceivable that aside from the functional layers listed above, at least one further functional layer is present.

It is preferably provided, in the case of the sealing film according to the invention, that the first color display layer and the second color display layer are structured in at least two different colors.

Preferably, the at least two different colors have very great contrast.

Within the scope of this invention, black and white are also considered colors.

It would be conceivable that both the first color display layer and the second color display layer consist of different colors, at least in certain sections, which colors are arranged in strip shape, for example.

Of course, the first color display layer and the second color display layer can also contain just one color, in each instance, wherein the color of the first color display layer differs from the color of the second color display layer.

Furthermore—as has already been explained above—the two color display layers can also consist of the same color.

It would furthermore be conceivable that the first color display layer consists of two different colors, for example of black and white, and the second color display layer consists of two different colors, for example of white and black, i.e. there is a strip-shaped or checkerboard-shaped arrangement of the two different colors, for example. However, the two different colors of the first color display layer are arranged differently, for example in mirror-inverted manner, from the two different colors of the second color display layer.

In a preferred embodiment of the sealing film according to the invention, it is provided that the at least one symbol is formed, in the second state, from at least one of the at least two colors. The at least one symbol is therefore visible in one of the at least two colors of the first and second color display layer, or in a mixed color composed of the at least two colors of the first and second color display layer.

A mixed color occurs, for example, from two color display layers that lie one on top of the other, wherein the color display layer that lies on top is not allowed to be opaque, in any case. In other words, for example a violet mixed color occurs if one of the two color display layers that lie one on top of the other is blue and another of the two color display layers that lie one on top of the other is red.

Preferably it is provided, in the case of the sealing film according to the invention, that at least one color is optically visible in the at least one symbol in the second state, which color is not optically visible in a region that surrounds the at least one symbol, at least in certain sections, and/or vice versa.

In other words, different colors are optically visible, in the second state, in the at least one symbol and in the region that surrounds the at least one symbol, at least in certain sections.

The following cases, in particular, are conceivable:

a) In the at least one symbol, one of the at least one color of the first color display layer and of the at least one color of the second color display layer is optically visible in the second state. In the region that surrounds the at least one symbol, at least in certain sections, accordingly a different color of the at least one color of the first color display layer and of the at least one color of the second color display layer is optically visible in the second state.

b) In the at least one symbol, one of the at least one color of the first color display layer and of the at least one color of the second color display layer is optically visible in the second state. In the region that surrounds the at least one symbol, at least in certain sections, a mixed color, which is composed of the at least one color of the first color display layer and of the at least one color of the second color display layer is optically visible in the second state.

c) In the at least one symbol, the mixed color is optically visible in the second state. In the region that surrounds the at least one symbol, at least in certain sections, one color of the at least one color of the first color display layer and of the at least one color of the second color display layer is optically visible in the second state.

d) The at least one symbol is transparent in the second state. In the region that surrounds the at least one symbol, at least in certain sections, the mixed color or one color of the at least one color of the first color display layer and of the at least one color of the second color display layer is optically visible in the second state.

e) The region that surrounds the at least one symbol, at least in certain sections, is transparent in the second state. In the at least one symbol, the mixed color or one color of the at least one color of the first color display layer and of the at least one color of the second color display layer is optically visible in the second state.

The colors separate in different combinations as the result of the detachment of the carrier film and the symbol appears, and thereby re-application of the carrier film onto the layers that lie underneath, without being optically evident, is almost entirely precluded, and assessment of the sealing film, even by a non-expert, clearly shows whether or not the sealing film was manipulated.

In a particularly preferred embodiment of the sealing film according to the invention, it is provided that the adhesion-controlling layers are release varnish layers that reduce the adhesion capacity of the first color display layer and the second color display layer as compared with adjacent layers of the sealing film. The adhesion-controlling layers comprise the first adhesion-controlling layer, the second adhesion-controlling layer, as well as the further adhesion-controlling layer. The term “adjacent layer” comprises the functional layers as well as the carrier film.

A lower adhesion capacity is generated for defined regions of the first color display layer and the second color display layer as compared with the regions excluded by the defined regions, in that release varnish layers, in each instance, border on the first color display layer and on the second color display layer, and thereby the two color display layers in those defined regions of lesser adhesion capacity, in known manner, do not permanently connect with a functional layer that borders on the release varnish layer, in particular not with the carrier film, and therefore remain easy to detach. In contrast, the regions of the layers that border on one another and are excluded by the defined regions on the basis of this arrangement can permanently connect with one another.

However, it would also be conceivable that the adhesion-controlling layers are layers that increase the adhesion capacity of the first color display layer and of the second color display layer as compared with adjacent layers of the sealing film. The method of effect would then be precisely opposite to what was said above.

The release varnish layers are preferably translucent, particularly preferably transparent.

Preferably, in the case of the sealing film according to the invention, it is provided that the release varnish layers comprise at least one silicone and/or at least one wax.

Thereby the adhesion capacity of those functional layers or of the carrier film or of the base surface on which the release varnish layer borders is lowered to a precisely measured degree by means of the release varnish layer, so that adjacent functional layers are adhesive to a lesser degree. The extent to which the adhesion capacity is reduced can be controlled, in particular, by way of the selection of the release varnish, by way of the layer thickness and/or by way of the concentration of the at least one silicone and/or of the at least one wax in the release varnish layer.

In a particularly preferred embodiment of the sealing film according to the invention, it is provided that the carrier film consists of transparent plastic. By means of the transparent configuration of the plastic, the at least two color display layers arranged below it are well visible at all times, and it is evident whether the at least two color display layers are distributed uniformly and therefore are untouched, or whether defined regions in the form of a graphic symbol have already been removed from the surface of the at least one color display layer, and thereby manipulation of the sealing film according to the invention has taken place.

Preferably a tab is provided in the case of the sealing film according to the invention, which is directly or indirectly connected with the carrier film. In other words, in the sense of improved operating convenience, the sealing film according to the invention has the tab, which is connected with the carrier film but not with the adhesive layer even in the second state.

The tab serves for grasping the sealing film according to the invention.

For example, the tab is an integral part of the carrier film, but it can also be a separate part affixed to the carrier film by means of a suitable method such as welding or gluing.

It is also possible that the tab is an integral component of one of the functional layers or is affixed to one of the functional layers by means of a suitable method such as welding or gluing.

It is conceivable that a sign is imprinted in the region of the tab, which shows a user the location at which the sealing film according to the invention can advantageously be grasped for pulling it off.

In a preferred exemplary embodiment of the sealing film according to the invention, it is provided that the tab is formed by means of a separate layer that is encompassed by the functional layers.

The tab is arranged within the functional layers, preferably not over their full area. In other words the at least one symbol forms at the transition of the sealing film according to the invention from the first state to the second state, preferably in a region next to the tab.

It would also be conceivable that an adhesive layer, for example a laminate adhesive layer, is part of the functional layers, which adhesive layer is not applied over the full area. For example, no adhesive layer can be applied in a region at a corner of the sealing film according to the invention, and thereby the carrier film can be detached from the functional layers particularly well at this corner, and thereby takes on the function of a tab.

### BRIEF DESCRIPTION OF THE FIGURES

The invention will now be explained in greater detail using exemplary embodiments. The drawings are examples and are intended to show the idea of the invention but by no means to restrict it or to reproduce it in conclusive manner.

In this regard, the figures show:

FIG. 1 a schematic representation of the structural structure of a first exemplary embodiment of a sealing film according to the invention, with a code within the functional layers,

FIG. 2 a schematic representation of the structural structure of a second exemplary embodiment of the sealing film according to the invention, with the code on a base surface,

FIG. 3a) a schematic representation of the first or second exemplary embodiment in a first state,

FIG. 3b) a schematic representation of a pulled-off layer of the first or second exemplary embodiment in a second state, after legitimate opening,

FIG. 3c) a schematic representation of a remnant of the first or second exemplary embodiment in the second state, on a base surface, after legitimate opening,

FIG. 3d) a schematic representation of a re-application of the pulled-off layer of the first or second exemplary embodiment glued back onto the remnant in the second state, after legitimate opening,

FIG. 4 a schematic representation of the structural structure of a third exemplary embodiment of the sealing film according to the invention, with the code within the functional layers,

FIG. 5a) a schematic representation of the third exemplary embodiment in the first state,

FIG. 5b) a schematic representation of the pulled-off layer of the third exemplary embodiment in the second state, after legitimate opening,

FIG. 5c) a schematic representation of the remnant of the third exemplary embodiment in the second state, on the base surface, after legitimate opening,

FIG. 5d) a schematic representation of the re-application of the pulled-off layer, glued back onto the remnant in the second state, after legitimate opening,

FIG. 5e) a schematic representation of the pulled-off layer of the third exemplary embodiment in the second state, after illegitimate opening,

FIG. 5f) a schematic representation of the remnant of the third exemplary embodiment in the second state, on the base surface, after illegitimate opening, and

FIG. 5g) a schematic representation of the re-application of the pulled-off layer, glued back onto the remnant in the second state, after illegitimate opening.

### WAYS TO IMPLEMENT THE INVENTION

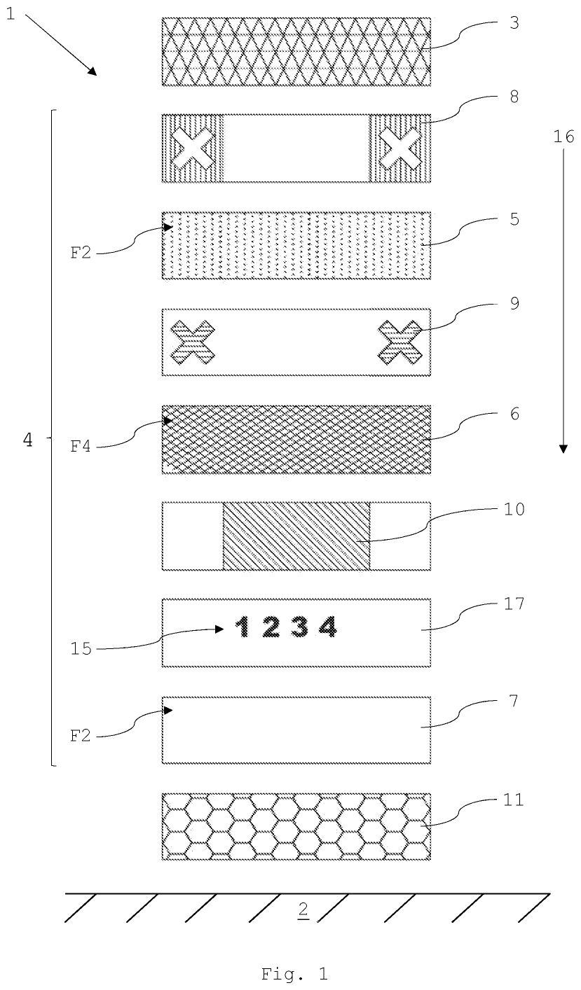

FIG. 1 shows a schematic representation of a structural structure of a sealing film 1 according to the invention with a code 15 within functional layers 4. The sealing film 1 according to the invention shown in FIG. 1 corresponds to a first exemplary embodiment.

It should be mentioned that within the scope of this invention, black and white are also viewed as being colors.

A first layer of the sealing film 1 according to the invention, seen in a first direction 16, is a carrier film 3 that consists of a transparent plastic film, preferably of polypropylene or polyethylene or polyethylene terephthalate. The plastic film can be matte or glossy. Furthermore, it would be conceivable that the plastic film is colored but not opaque.

A rearmost layer of the sealing film 1 according to the invention, seen in the first direction 16, is an adhesive layer 11 that can adhere to a base surface 2, wherein the base surface 2 is a sheet of paper or a cardboard. In other words, the sealing film 1 according to the invention, applied to the base surface 2 by means of the adhesive layer 11, can be released from the base surface 2 only by application of force, and remains on the base surface 2, in part, even during a detachment process of the sealing film 1, which will be described below. The part of the sealing film 1 according to the invention that remains on the base surface 2 is referred to as a remnant 19. The self-adhesive function of the adhesive layer 11 can be protected by means of a film, for example, which is pulled off before applying or affixing the sealing film 1 to the base surface 2. In order to guarantee such a solid connection with the surface of a base surface 2, a correspondingly strong adhesive, for example a pressure-sensitive adhesive, must be used. The pressure-sensitive adhesive can be acrylic-based or natural-rubber-based, and it can be dispersed in water, dissolved in solvent or applied as a hot-melt glue, for example.

Alternatively, a heat-sealing adhesive could also be used for the production of a solid connection between the sealing film 1 and the surface of the base surface 2.

The following functional layers 4 are arranged between the carrier film 3 and the adhesive layer 11.

A first color display layer 5 lies behind the carrier film 3, viewed in the first direction 16, and in this exemplary embodiment is kept in the color white F2. Fundamentally, however, the color can be selected in any desired manner.

A first adhesion-controlling layer 8, which in the exemplary embodiment shown is a first release varnish layer 8, which comprises at least one silicone and/or at least one wax, is arranged between the carrier film 3 and the first color display layer 5.

It should be noted that alternative substance mixtures can also be used as release varnish layers 8, 9, 10. However, it is essential, in this regard, that the release varnish layers 8, 9, 10 in the exemplary embodiment shown have suitable adhesion-reducing properties, so as to reduces an adhesion capacity of those layers (a functional layer 4 or the carrier film 3) to which the corresponding release varnish layer 8, 9, 10 is applied to a precisely dimensioned degree, so that adjacent layers adhere or are adhesive to a lesser degree.

A second color display layer 6 is arranged behind the first color display layer 5, viewed in the first direction 16, which layer is black F4 in this exemplary embodiment. The color of the second color display layer 6 can, however, be chosen as desired. Preferably, the first color display layer 5 and the second color display layer 6 consist of contrasting colors, and thereby at least one contrast-rich symbol 12 is formed during the course of the detachment process, if a corresponding arrangement is present.

A second adhesion-controlling layer 9, which in the exemplary embodiment shown is a second release varnish layer 9, which comprises at least one silicone and/or at least one wax, is arranged between the first color display layer 5 and the second color display layer 6.

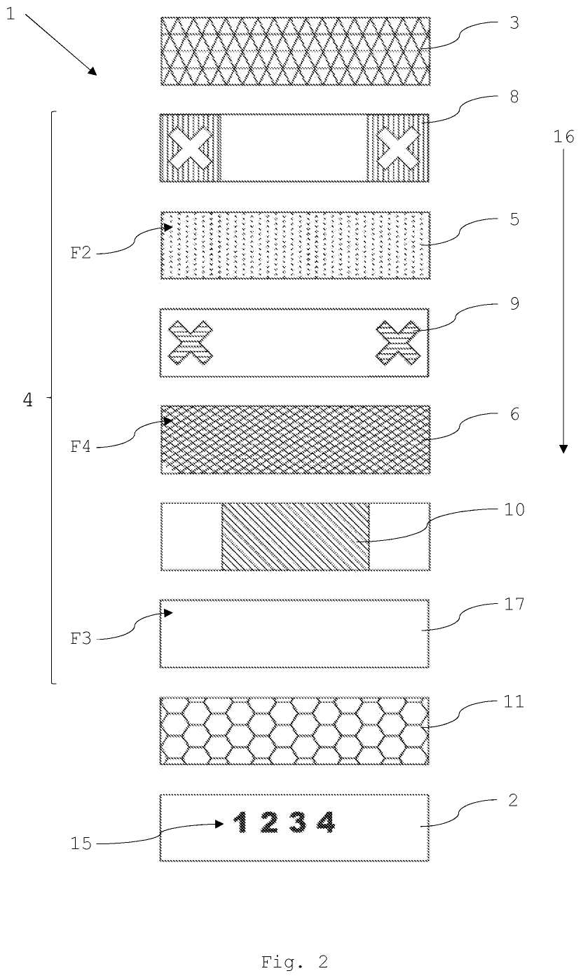

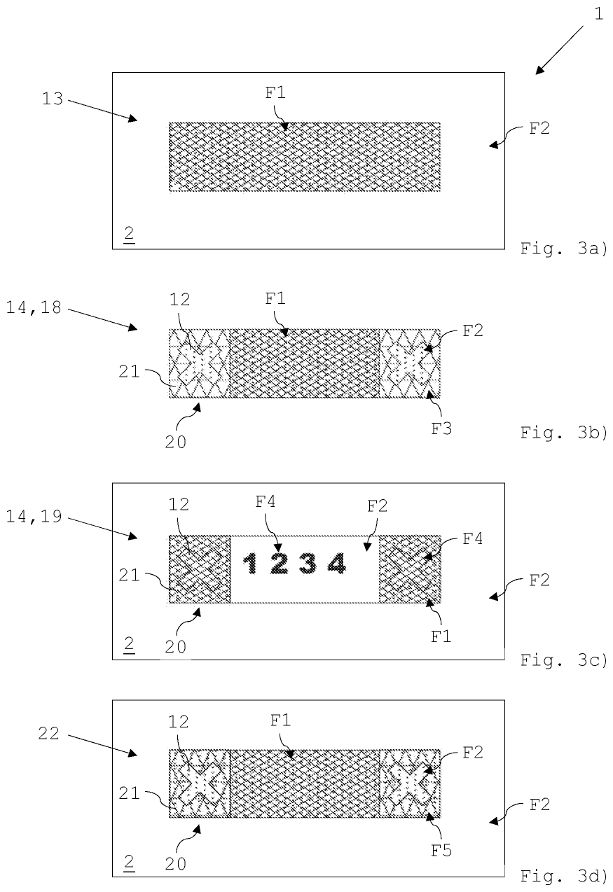

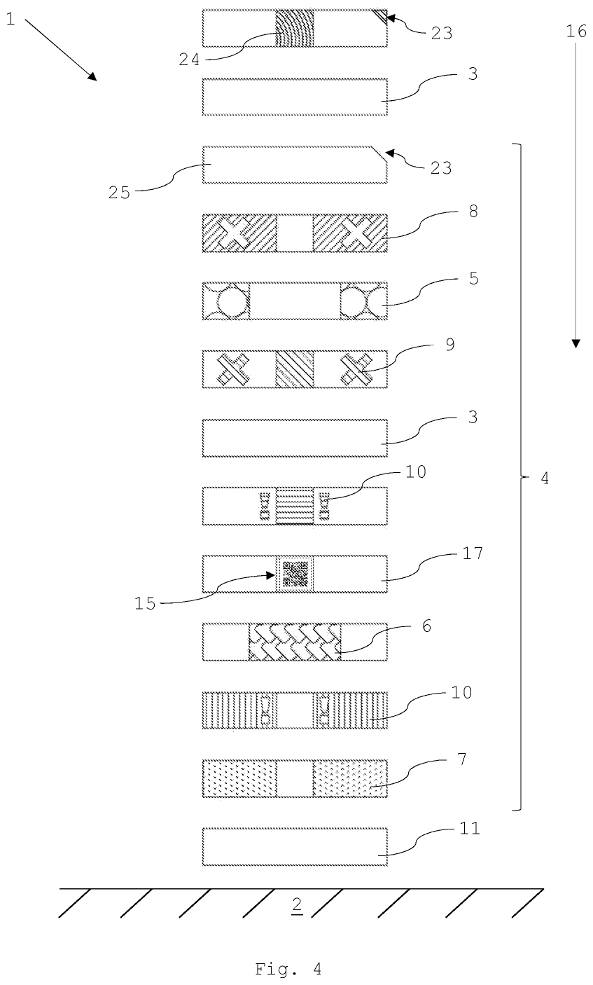

In the exemplary embodiments of FIG. 1 and FIG. 2, a further adhesion-controlling layer 10, which is a further release varnish layer 10 that comprises at least one silicone and/or at least one wax in the exemplary embodiment shown, is arranged behind the second color display layer 6, viewed in the first direction 16, as is a layer 17 that lies behind the further adhesion-controlling layer 10. The layer 17 that lies behind the further adhesion-controlling layer 10 is transparent and comprises a code 15. In the exemplary embodiment shown in FIG. 1, FIG. 2, and FIG. 3c, the code 15 is a numerical combination composed of black characters. However, it would also be conceivable that the code 15 is a QR code (see FIG. 4), a graphic symbol, or the like.

The code 15 is not visible in a first state 13 of the sealing film 1, and only becomes visible after detachment of the carrier film 3, in other words in a second state 14 of the sealing film 1. The transition from the first state 13 to the second state 14 thereby corresponds to the detachment process mentioned above.

A further color display layer 7 is arranged behind the layer 17 that lies behind the further adhesion-controlling layer 10, viewed in the first direction 16, which layer is white F2 in the exemplary embodiment of FIG. 1. However, a different color would also be conceivable, wherein preferably a color is selected that has great contrast to the color of the code 15. In this way it is guaranteed that the code 15 is legible even under adverse viewing conditions. In other words, on the one hand the further color display layer 7 has the task of making the code 15 legible. On the other hand, the further color display layer 7 also serves as a privacy shield for the code 15, in the event that the sealing film 1 according to the invention, including all of the functional layers 4, has been improperly removed from the base surface, for example using a tool. If the further color display layer 7 has sufficient coverage, i.e. it is not or barely transparent, the code 15 does not show through the further color display layer 7, and therefore also cannot be read through the back side, i.e. through the further color display layer 7, of the sealing film 1 according to the invention.

In this exemplary embodiment, the functional layers 4 thereby comprise, viewed in the first direction 16, the first release varnish layer 8, the first color display layer 5, the second release varnish layer 9, the second color display layer 6, the further release varnish layer 10, the layer 17 that lies behind the further release varnish layer 10, and the further color display layer 7.

A second exemplary embodiment of the sealing film 1 according to the invention is disclosed in FIG. 2. FIG. 2 shows a schematic representation of the structural structure of the second exemplary embodiment of the sealing film 1 according to the invention, with the code 15 on the base surface 2.

The sealing film 1 according to the invention has the same structure in FIG. 2 as in FIG. 1, with the sole difference that the layer 17 that lies behind the further release varnish layer 10 does not contain a code 15. This is because in this exemplary embodiment the code 15 is situated on the base surface 2 and is not part of the functional layers 4. In the first state 13, the code 15 is covered by the sealing film 1 according to the invention. In other words, in this exemplary embodiment, as well, the code 15 is not visible in the first state 13, and only becomes visible after detachment of the carrier film 3, in other words in the second state 14.

Both the adhesive layer 11 and the layer 17 that lies behind the further adhesion-controlling layer 10 are configured to be transparent, at least in the region of the code 15, so as to make the code 15, which is situated on the base surface 2, visible in the second state 14. The further color display layer 7 is eliminated in this exemplary embodiment.

In this exemplary embodiment, the layer 17 that lies behind the further release varnish layer 10 guarantees the effect of the further release varnish layer 10, because it is ensured by the layer 17 that lies behind the further release varnish layer 10 that the further release varnish layer 10 does not come into direct contact with the adhesive layer 11.

Furthermore, it would be conceivable, in the case of the two exemplary embodiments shown (see FIG. 1 and FIG. 2), that the sealing film 1 according to the invention has a tab (not shown), which is connected with the carrier film 3. The said tab facilitates pulling off the carrier film 3 for the user, i.e. facilitates the transition of the sealing film 1 according to the invention from the first state 13 to the second state 14.

FIG. 3a) to d) show, as examples, the sealing film 1 according to the invention in the first state 13 (FIG. 3a)) and in the second state 14 after legitimate opening (FIG. 3b) to FIG. 3d)). In this regard, FIG. 3a) to d) cover both the first exemplary embodiment from FIG. 1 and the second exemplary embodiment from FIG. 2. In other words, it makes no difference for the representations in FIG. 3a) to d) whether the code 15 is situated on the layer 17 that lies behind the further release varnish layer 10 and is therefore part of the functional layers 4, or whether the code 15 is arranged on the base surface 2.

FIG. 3a) shows a schematic representation of the sealing film 1 according to the invention in the first state 13. The sealing film 1 according to the invention is glued onto the base surface 2, which is white F2, for example, using the adhesive layer 11, and it is cohesive, i.e. it was not previously manipulated. In the first state 13, the entire sealing film 1 according to the invention is dark-gray F1, for example. In the example shown, the dark-gray color F1 results from intimate contact of the first color display layer 5, which is white F2, and the second color display layer 6, which is black F4.

Of course, it would be conceivable that the sealing film 1 according to the invention has different colors and color combinations in the first state 13 and also in the second state 14.

FIG. 3b) discloses a schematic representation of a pulled-off layer 18 in the second state 14, after legitimate opening. The pulled-off layer 18 is the carrier film 3 including the color display layers 5, 6 that adhere to the carrier film 3.

FIG. 3c) shows a schematic representation of the remnant 19 in the second state 14, on the base surface 2, after legitimate opening. The remnant 19 is the parts of the functional layers 4 that remain on the base surface 2.

In the second state 14, two symbols 12 are now optically visible in two outer regions 20 that lie opposite one another, wherein the two symbols 12 occur during detachment of the carrier film 3, by means of the release varnish layers 8, 9, which remove defined regions from the two color display layers 5, 6.

The first release varnish layer 8 ensures that the color display layers 5, 6 remain on the remnant 19 in those regions 21 that surround the two symbols 12. Accordingly, the regions 21 that surround the symbols 12 are dark-gray F1 on the remnant 19 and transparent F3 on the pulled-off layer 18.

The second release varnish layer 9 separates the first color display layer 5 and the second color display layer 6 and ensures the color configuration of the two symbols 12. Thereby the symbols 12 are white F2 on the pulled-off layer 18 and black F4 on the remnant.

In the exemplary embodiments of FIG. 1, FIG. 2, FIG. 3, and FIG. 4 and others, the symbols 12 are structured in the form of an “X”. However, it would also be possible, of course, that the symbols 12 have any desired shape.

The further release varnish layer 10 is responsible for the fact that the code 15 becomes visible. As has already been described above, it is not relevant for making the code 15 visible whether the code 15 is arranged on the layer 17 that lies behind the further release varnish layer 10, according to FIG. 1, or whether the code 15 is arranged on the base surface 2 underneath the adhesive layer 11, according to FIG. 2.

All of the layers that lie in front of the further release varnish layer 10, viewed in the first direction 16, are pulled off from the further release varnish layer 10 in those regions in which the further release varnish layer 10 is applied, using the carrier film 3. As a result, the code 15, which is situated in the center region of the sealing film 1 according to the invention in these exemplary embodiments, becomes visible on the remnant 19. A strong contract occurs between the code 15, the characters of which are typically structured in black F4, and the further color display layer 7 or the base surface 2, due to the white F2 configuration of the further color display layer 7 or the base surface 2, and thereby the code 15 is well legible. Accordingly, this center region is dark-gray F1 on the pulled-off layer 18.

FIG. 3d) shows a schematic representation of a re-application 22 of the pulled-off layer 18 glued back onto the remnant 19 in the second state 14, after legitimate opening. It is evident that the symbols 12 are visible on the remnant 19 even after the re-application 22 of the pulled-off layer 18 onto the remnant 19. In other words the manipulation of the sealing film 1 according to the invention that took place previously is indicated by a clear identification of the opened state, in that the symbols 12 are visible even after the re-application 22.

The regions that are situated one on top of the other after the re-application 22 do not yield any strong mixed colors, since no intimate contact occurs between the color display layers 5, 6 during the re-application 22. Due to the detachment of the carrier film 3 including the color display layers 5, 6 that adhere to the carrier film 3, rough surfaces occur between the pulled-off layer 18 and the remnant 19. During the re-application 22, intimate contact between the pulled-off layer 18 and the remnant 19 cannot be produced, as has been described above. In other words the different color pigments no longer bind to one another as strongly. In addition, air collects between the pulled-off layer 18 and the residue 19 during the course of the re-application 22, and this air can no longer fully escape after the re-application 22, and thereby the mixed colors are also impaired.

After the re-application 22 of the pulled-off layer 18 to the remnant 19, the symbols 12 continue to be white F2, since the symbols 12 are white F2 on the pulled-off layer 18, and during the re-application 22 they cover the black color F4 of the symbols 12 on the remnant 19.

Since the dark-gray F1 regions 21 of the remnant 19 are covered by the transparent F3 regions 21 of the pulled-off layer 18, slight brightening of the dark-gray F1 regions 21 of the remnant 18 comes about, and thereby the regions 21 appear gray F5 after the re-application 22.

After the re-application 22, the center region, in which the code 15 is arranged, appears dark-gray F1, since the dark-gray color F1 of the pulled-off layer 18 completely covers the code 15.

Because of the fact that the two symbols 12 are visible even after the re-application 22, an observer immediately recognizes that the sealing film 1 according to the invention has already been opened previously, and that the code 15 was possibly read by someone else.

FIG. 4 shows a schematic representation of the structural structure of a third exemplary embodiment of the sealing film 1 according to the invention, with the code 15 within the functional layers 4.

A first layer of the sealing film 1 according to the invention, viewed in the first direction 16, is a cover color 24, which serves to characterize a region of the code 15 and a region of a tab 23, and to additionally cover the code 15. In this exemplary embodiment, the carrier film 3 lies behind the cover color 24, viewed in the first direction 16, and consists of a transparent plastic film.

A rearmost layer of the sealing film according to the invention, seen in the first direction 16, is the adhesive layer 11, which can adhere to the base surface 2. Subsequent functional layers 4 are arranged between the carrier film 3 and the adhesive layer 11.

A laminate adhesive layer 25 lies directly behind the carrier film 3, viewed in the first direction 16, and serves, in this exemplary embodiment, for excluding the tab 23, so as to make easy pulling-off possible. The laminate adhesive layer 25 is not applied over the full area—no laminate adhesive layer 25 is applied at a corner of the sealing film 1 according to the invention, and thereby the carrier film 1 can be detached particularly easily there.

The first color display layer 5 lies behind the carrier film 3, viewed in the first direction 16. The first release varnish layer 8, which comprises at least one silicone and/or at least one wax, is arranged between the carrier film 3 and the first color display layer 5.

A second carrier film 3 is arranged behind the first color display layer 5, viewed in the first direction 16. The second release varnish layer 9 is arranged between the first color display layer 5 and the second carrier film 3.

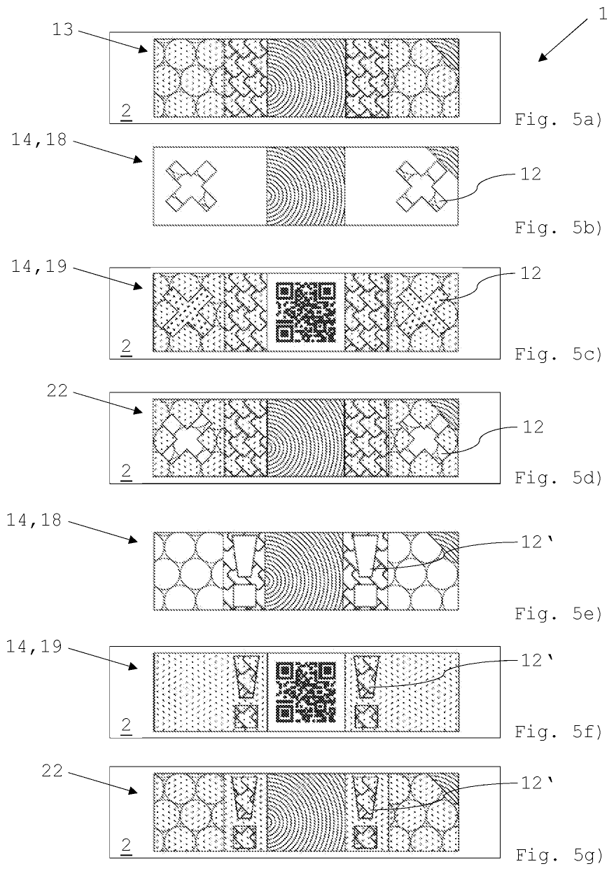

Using those functional layers 4 that are arranged between the carrier film 3 and the second carrier film 3, two symbols 12 in the form of two “X”s become visible in the second state 14 after legitimate opening (see FIG. 5b), FIG. 5c), and FIG. 5d)).

The further release varnish layer 10, as well as the layer 17 that lies behind the further release varnish layer 10 are arranged behind the second carrier film 3, viewed in the first direction 16. The layer 17 that lies behind the further release varnish layer 10 is transparent and comprises the code 15. In this exemplary embodiment, the code 15 is a QR code.

The second color display layer 6 is arranged directly behind the layer 17 that lies behind the further release varnish layer 10, viewed in the first direction 16.

An additional release varnish layer 10 is arranged directly behind the second color display layer 6, viewed in the first direction 16.

The further color display layer 7 is arranged behind the additional release varnish layer 10.

As the result of the functional layers 4 between the second carrier film 3 and the adhesive layer 11, two symbols 12′—in the exemplary embodiment shown, in the form of two “exclamation marks”—become visible in the second state, even after illegitimate opening (see FIG. 5e), FIG. 5f), and FIG. 5g)). In other words, if the sealing film 1 according to the invention was illegitimately removed from the base surface, for example using a tool, two symbols 12′ are visible in this exemplary embodiment—in precisely the same way as after legitimate opening.

FIG. 5a) shows a schematic representation of the third exemplary embodiment in the first state 13. The sealing film 1 according to the invention is glued onto the base surface 2 using the adhesive layer 11, and is cohesive. It was not manipulated previously, and therefore no symbols 12 are visible.

FIG. 5b) shows a schematic representation of the pulled-off layer 18 of the third exemplary embodiment in the second state 14, after legitimate opening. The pulled-off layer 18 is the carrier film 3 including the cover color 24 adhering to the carrier film 3, as well as adhering parts of the first color display layer 5.

FIG. 5c) shows a schematic representation of the remnant 19 of the third exemplary embodiment in the second state 14, on the base surface 2, after legitimate opening. The remnant 19 is the parts of the functional layers 4 that remained on the base surface 2, including the adhesive layer 11.

In the second state 14, two symbols 12 in the form of two “X”s are optically visible after legitimate opening.

FIG. 5d) shows a schematic representation of the re-application 22 of the pulled-off layer 18, glued back onto the remnant 19 in the second state 14, after legitimate opening. It is evident that the symbols 12 are visible on the remnant 19 even after the re-application 22 of the pulled-off layer 18. In other words the manipulation of the sealing film 1 according to the invention that preceded the re-application 22 is indicated by means of clear identification of the open state, in that the symbols 12 are visible even after the re-application 22.

FIG. 5e) shows a schematic representation of the pulled-off layer 18 of the third exemplary embodiment in the second state 14, after illegitimate opening. In this exemplary embodiment the pulled-off layer 18 is the carrier film 3 including the cover color 24 that adheres to the carrier film 3, as well as functional layers 4 that are arranged between the carrier film 3 and the second carrier film 3, and part of the second color display layer 6.

In the second state 14, two symbols 12′ in the form of two “exclamation marks” are optically visible after illegitimate opening. As has already been mentioned above, in this exemplary embodiment illegitimate opening of the sealing film 1 according to the invention is also directly evident to the observer.

FIG. 5f) shows a schematic representation of the remnant 19 of the third exemplary embodiment in the second state 14, on the base surface 2, after illegitimate opening. The remnant 19 is the parts of the functional layers 4 remaining on the base surface 2, including the adhesive layer 11.

FIG. 5g) shows a schematic representation of the re-application 22 of the pulled-off layer 18, glued back onto the remnant 19 in the second state 14, after illegitimate opening. It is evident that the symbols 12′ are visible on the remnant 19 even after the re-application 22 of the pulled-off layer 18. In other words, in this exemplary embodiment the manipulation of the sealing film 1 according to the invention that preceded the re-application 22 is indicated by means of clear identification of the illegitimately opened state, in that the symbols 12′ are visible even after the re-application 22.

### REFERENCE SYMBOL LIST

1 sealing film
2 base surface
3 carrier film
4 functional layers
5 first color display layer
6 second color display layer
7 further color display layer
8 first adhesion-controlling layer or first release varnish layer
9 second adhesion-controlling layer or second release varnish layer
10 further adhesion-controlling layer or further release varnish layer
11 adhesive layer
12, 12′ symbol
13 first state
14 second state
15 code
16 first direction
17 layer that lies behind the further adhesion-controlling layer or layer that lies behind the further release varnish layer
18 pulled-off layer
19 remnant
20 outer region
21 a region that surrounds the symbol
22 re-application
23 tab
24 cover color
25 laminate adhesive layer
F1 dark-gray
F2 white
F3 transparent
F4 black
F5 gray

1. A sealing film (1) for application to a base surface (2), comprising a carrier film (3) and multiple functional layers (4), wherein the functional layers (4) comprise at least two color display layers (5, 6) and at least two adhesion-controlling layers (8, 9), wherein the sealing film (1) has an adhesive layer (11) for attachment to the base surface (2), wherein the functional layers (4) are arranged between the carrier film (3) and the adhesive layer (11), wherein the carrier film (3) can be at least partially detached from the functional layers (4), so as to bring the sealing film (1) from a first state (13) into a second state (14), wherein in the second state at least one symbol (12) is optically visible, which symbol (12) is not visible in the first state (13), wherein the at least two adhesion-controlling layers (8, 9) are provided so as to separate defined regions out from the at least two color display layers (5, 6), and to make the at least one symbol (12) visible, during detachment of the carrier film (3), wherein the functional layers (4) comprise at least one further adhesion-controlling layer (10), so as to make at least one layer (17) that lies behind the further adhesion-controlling layer (10), viewed from the carrier film (3) in the direction of the adhesive layer (11), visible in the second state (14), at least in certain sections, by means of the detachment.

2. The sealing film according to claim 1, wherein the layer (17) that lies behind the further adhesion-controlling layer (10) comprises at least one code (15) composed of optical characters and/or graphical symbols.

3. The sealing film (1) according to claim 2, wherein the layer (17) that lies behind the further adhesion-controlling layer (10) is transparent, at least in certain sections, and is encompassed by the functional layers (4), and wherein the functional layers (4) comprise at least one further color display layer (7), which further color display layer (7) is arranged between the layer (17) that lies behind the further adhesion-controlling layer (10) and the adhesive layer (11).

4. The sealing film (1) according to claim 3, wherein at least the following functional layers (4) are applied to the carrier film (3), one after the other, viewed in the direction of the adhesive layer (11):
a first adhesion-controlling layer (8),
a first color display layer (5),
a second adhesion-controlling layer (9),
a second color display layer (6),
the further adhesion-controlling layer (10),
the layer (17) that lies behind the further adhesion-controlling layer (10), and
the further color display layer (7).

5. The sealing film (1) according to claim 1, wherein the layer (17) that lies behind the further adhesion-controlling layer (10) and the adhesive layer (11) are transparent, at least in certain sections, so as to make a code (15) visible on the base surface (2) in the second state (14).

6. The sealing film (1) according to claim 5, wherein at least the following functional layers (4) are applied to the carrier film (3), one after the other, viewed in the direction of the adhesive layer (11):
a first adhesion-controlling layer (8),
a first color display layer (5),
a second adhesion-controlling layer (9),
a second color display layer (6),
the further adhesion-controlling layer (10), and
the layer (17) that lies behind the further adhesion-controlling layer (10).

7. The sealing film (1) according to claim 4, wherein the first color display layer (5) and the second color display layer (6) are structured in at least two different colors.

8. The sealing film (1) according to claim 7, wherein the at least one symbol (12) is formed, in the second state (14), from at least one of the at least two colors.

9. The sealing film (1) according to claim 8, wherein at least one color is optically visible in the at least one symbol (12) in the second state (14), which color is not optically visible in a region (21) that surrounds the at least one symbol (12), at least in certain sections, and/or vice versa.

10. The sealing film (1) according to claim 4, wherein the adhesion-controlling layers (8, 9, 10) are release varnish layers (8, 9, 10) that reduce the adhesion capacity of the first color display layer (5) and the second color display layer (6) as compared with adjacent layers of the sealing film (1).

11. The sealing film (1) according to claim 10, wherein the release varnish layers (8, 9, 10) comprise at least one silicone and/or at least one wax.

12. The sealing film (1) according to claim 1, wherein the carrier film (3) comprises transparent plastic.

13. The sealing film (1) according to claim 1, wherein a tab (23) is provided, which is directly or indirectly connected with the carrier film (3).

14. The sealing film (1) according to claim 13, wherein the tab (23) is formed by a separate layer that is encompassed by the functional layers (4).

15. The sealing film (1) according to claim 1, wherein the carrier film (1) can be detached, at least partially, from the at least two color display layers (5, 6).

16. The sealing film (1) according to claim 4, wherein at least the following functional layers (4) are applied to the carrier film (3), viewed in the direction of the adhesive layer (11), directly one after the other:
a first adhesion-controlling layer (8),
a first color display layer (5),
a second adhesion-controlling layer (9),
a second color display layer (6),
the further adhesion-controlling layer (10),
the layer (17) that lies behind the further adhesion-controlling layer (10), and
the further color display layer (7).

17. The sealing film (1) according to claim 6, wherein at least the following functional layers (4) are applied to the carrier film (3), viewed in the direction of the adhesive layer (11), directly one after the other:
a first adhesion-controlling layer (8),
a first color display layer (5),
a second adhesion-controlling layer (9),
a second color display layer (6),
the further adhesion-controlling layer (10), and
the layer (17) that lies behind the further adhesion-controlling layer (10).
